(19) United States
(12) Patent Application Publication
(10) Pub. No.: US 2006/0158308 A1
(43) Pub. Date: Jul. 20, 2006

(54) System and method for automatically generating, collecting, monitoring and acting on information in an institutional setting

(76) Inventors: Benjamin Clayton Arthur McMullen, Chesterland, OH (US); Nicholas Andrew Pirc, Chesterland, OH (US); Claire Renee Slusarz, Chesterland, OH (US); Mariah Leigh Wright, Chesterland, OH (US)

Correspondence Address: Clay McMullen, 9744 Sherman Road, Chesterland, OH, 44056, US

(21) Appl. No.: 11/325,173

(22) Filed: Jan. 4, 2006

Related U.S. Application Data
(60) Provisional application No. 60/641,605, filed on Jan. 6, 2005.

(51) Int. Cl. G05B 19/00; G09B 3/00

(52) U.S. Cl. 340/5.61; 340/5.4; 340/10.42; 340/572.1; 340/5.73; 434/351

(57) ABSTRACT

This invention relates to methods and system for wireless data capture and transaction processing in institutional environments in which time-sensitive actions can be automated and decision made based on real-time or near real-time information about the location and/or status of people and objects.

### CROSS REFERENCE TO RELATED APPLICATIONS

This application claims priority to U.S. Provisional Application No. US60/641,605, filed Jan. 6, 2005, entitled Smartschool, which is incorporated herein by reference in its entirety.

### GOVERNMENT RIGHTS

The Federal Government has no rights in this invention.

### FIELD OF THE INVENTION

The invention relates to systems and methods, for generating, collecting, monitoring and acting on certain types of information, using radio frequency identification (RFID) technology in an institutional setting, such as a school.

### BACKGROUND

Michael Faraday, an English scientist, discovered in 1864 that radio waves are a form of electromagnetic energy. Heinrich Hertz, a German physicist, was the first person to transmit and receive radio waves, in 1887.

The concept of Radio Frequency Identification (RFID), which was used in rudimentary form in World War II to distinguish British from German aircraft, was articulated by Mr. Harry Stockman in a paper in 1948. From 1950 to 1960, early explorations of RFID technology began, principally in laboratory experiments. During the 1960's, understanding of how component parts of RFID systems should work together evolved, and early field trials commenced. During the 1970's, RFID technology progressed further and early adopters began using simple RFID devices. For example, the Port Authority of New York and New Jersey started testing RFID on toll roads for toll collection.

During the 1980's, early commercial applications began being used by mainstream businesses. During the 1990's, RFID became more common in toll collection on highways. Standards began to be developed for readers and tags.

In the past ten years, three continuing advances have worked together to make RFID more useful. First, standards for RFID systems (e.g., electronic product codes for retailers) continue to be adopted and refined. Second, the cost of tags and readers has been dropping rapidly. Tags can cost as little as ten cents and should continue to go down in the future. Similarly, readers continue to fall in price. Third, computer software continues to improve, permitting people to better organize and analyze the data recorded by RFID devices.

A typical RFID system has three main parts: tag, reader and controller. Tags each have an antenna that communicates with the reader. There are two different kinds of tags, passive and active. Passive tags are smaller (as small as a grain of rice) and less expensive to manufacture, but they don't hold a lot of information, often just an identification number. For passive tags, a tiny electrical current generated in the antennae by an incoming radio signal emitted by a reader provides power for the tag to respond. Active tags can hold more information than passive ones. Active RFID tags, must have a power source, so they have a battery to receive and transmit data. They can have long memories and longer ranges than passive tags. Different combinations of RFID tags and readers have various reading ranges, from several millimeters to hundreds of feet.

Controllers are computers used with RFID technology. A controller typically has a software program loaded on it that assesses the information it receives from the reader. Different kinds of controllers can hold different amounts of information, and sort it in different ways.

RFID systems may be used to track things from exotic animals, to pallets of foods, to medicine bottles. People in Japan, in particular, have reportedly been developing new uses for RFID, including putting tags into clothing and school bags of students to help prevent kidnapping.

As promising as it is, there are some problems that must be overcome for RFID use to become more widespread. Because it does not work on line of sight, any tags within a certain range may respond to a reader. This could cause confusion in some circumstances. Since RFID uses radio waves, existing wireless networks can cause interference. Water can also interfere with the capacity of a reader to read a tag.

Beyond such technical issues, however, is the larger challenge of adapting RFID technology to uses where the automatic generation, collection, storage and monitoring of information can improve management, administration and safety on a cost-effective basis. For example, institutional environments occupied by substantial numbers of people in various specified locations involved in complex activities, such as, e.g., schools, present many challenges to those responsible for administrative and management tasks like taking attendance of personnel, tracking inventories of equipment and consumables, monitoring current locations of people and things, and effecting appropriate security measures to control ingress and egress to certain spaces, and the like. Carrying out such tasks imposes certain fundamental information requirements that have historically been carried out through manual means of gathering, organizing and reporting information and making administrative decisions. Even in environments with computer networks, critical information must typically be gathered and input to the network manually, generally through typing. Frequently, such information is inaccurate; may quickly become obsolete; is subject to human error in collection, organization and reporting; necessitates maintenance of paper records and files to preserve; and often is not available at all, or in a timely fashion to decision-makers. Further, substantial amounts of people's time and energy, in addition to other resources are required in order to maintain and operate the manual systems to attempt to collect such information. As a consequence, management and administrative decision-making and actions are frequently based upon inaccurate and/or untimely information or in the absence of certain relevant information. Moreover, in a school environment, where managers and administrators have heightened responsibilities to supervise the actions of children and attend to their safety and welfare, the consequences of such limitations may be particularly acute. Accordingly, there is a great need for better, faster, more accurate, more efficient, more cost-effective information gathering, transmission, storage, analysis and reporting solutions in school environments.

### SUMMARY OF THE INVENTION

The identification and harnessing of radio waves transformed communications, much as the invention of computers has transformed information processing. Combining these basic technologies to create and automate certain information gathering and management systems and methods could address the above-referenced deficiencies and improve such systems and methods.

The present invention overcomes the disadvantages and limitations of the prior art by applying technology that enables wireless data capture and transaction processing in novel ways to the school institutional environment, creating the potential for real-time or near real-time collection of information which will be more accurate and reliable, thereby improving decisions based thereon. For ease of reference, such wireless data capture and transaction processing technology is referred to as “RFID,” but the present invention should be understood to incorporate other equivalent forms of wireless data capture and transaction processing technology.

The present invention comprises a system for gathering, transmission, storage, analysis of information in institutional environments such as schools, comprised of multiple RFID tags placed on various items and persons, multiple RFID readers located throughout the environment, a server to receive signals from the readers, a database containing information about the environment and a plurality of task descriptions, one or more software programs including decision rules and capable of performing one or more functions associated with activities in the institutional environment. By way of illustration, these functions may include tracking attendance of each student in each class; alerting students if there is a problem and locking a door and denying access to someone if they should not enter a given room; tracking medicine for students, generating a notice to students to go to the school nurse who can monitor which students receive which medications; tracking library books and expensive equipment, such as musical instruments, possibly without the need for a library check-out person, and locking the library door if someone attempts to walk out with something they should not take; tracking certain sensitive papers such as student records or state proficiency tests; tracking student lunch accounts and food item containers, so that there will be no need for cashiers, enabling students to just walk past a reader with their lunches and charging their accounts on an automated basis; assisting blind students by informing them where they are and identifying locations and things in the environment; sending an emergency message when an emergency arises, for example by flashing an LED light on the tag; and providing reports to administrators of system operation, such as through personal computers connected to the system.

The invention may further comprise a method for gathering, transmitting, storing and analyzing information in an institutional environment such as a school, by generating signals containing information specific to the bearer of the RFID tag, sending the signal, reading the signal, forwarding the signal to a controller, identifying the specific tag generating the signal, applying relevant decision rules to the information in the signal, generating a response or order based on such decision rules, performing a function based on such response or order, and creating and sending a report of the foregoing process to an administrative authority.

### BRIEF DESCRIPTION OF DRAWINGS

The present invention may be more readily understood by reference to the following drawings wherein. FIG. 1 shows a diagram of a basic RFID system.

In FIG. 2, each student receives an RFID tag, either as a bracelet (210), dog tag (220), or ID card (230). The tag has their photo on it (232) and a unique RFID identification code (ID tag). In one embodiment of the present invention, an ID tag may contain a biometric identifier based on, for example, a student's fingerprint (234) such that only that student may activate or de-activate the ID tag.

FIG. 3 is a sketch of a student locker (310) that has a door (315) that rolls up automatically when the student to whom the locker belongs gets close enough to it with her ID tag. In one embodiment, the student puts her finger on her ID tag to verify her identification, activate the ID tag and cause the locker door to open. Because the reader on each locker attaches to the door, each locker has about 2″ more of space than with old lockers with a thick steel frame.

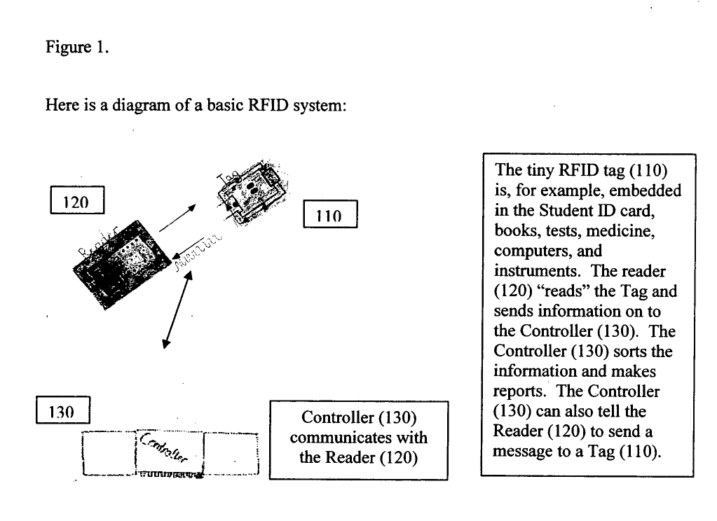

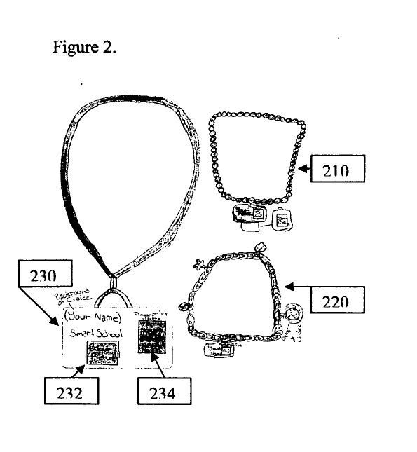

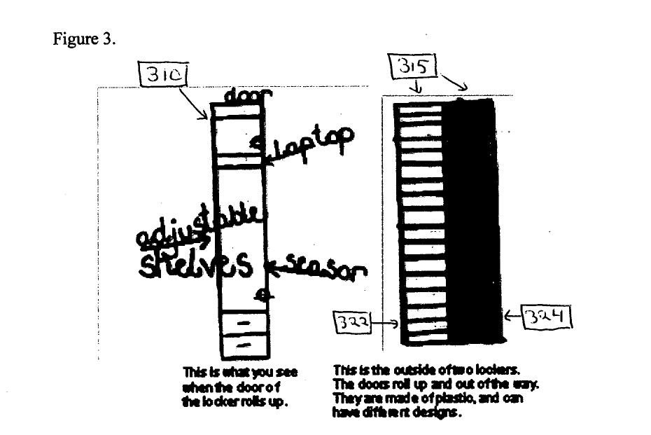

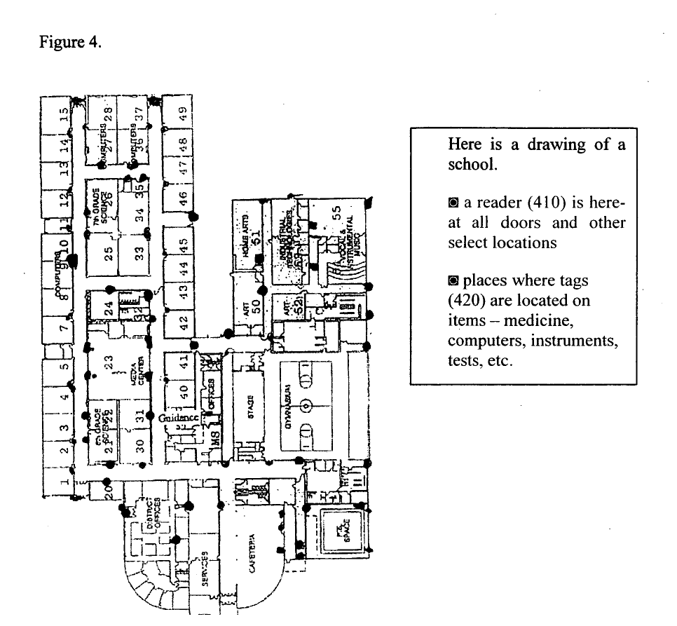

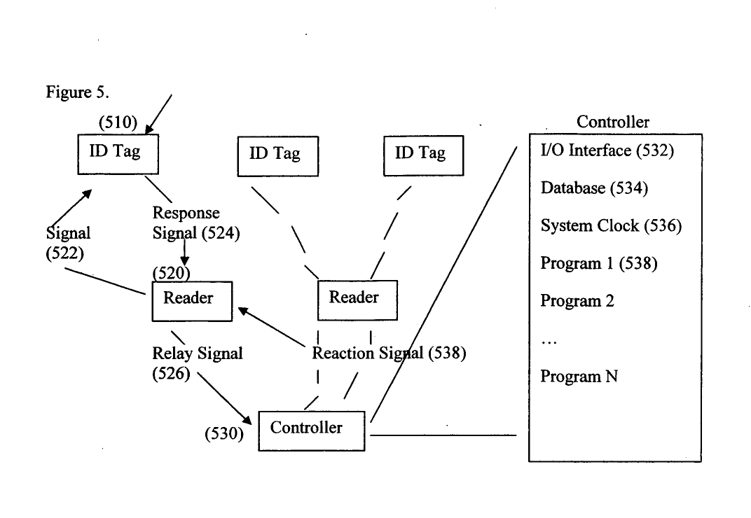

When the door (315) of the locker (310) rolls up, it makes shelves and storage areas accessible to the student. Lockers and/or locker doors may be made of a lightweight material, such as plastic or PVC, and can be made in different designs (322, 324).

In FIG. 4, readers (410) may be located at various locations throughout an institution. Tags (420) may be placed on various objects or items which may be mobile or remain in place.

As shown in FIG. 5, in one embodiment of the invention, the reader (520) generates a radio signal that is received by an ID tag (510) which sends a response signal (524) that is unique to said ID tag (510). The response signal (524) is then relayed by the reader (520) to the controller (530), where it is received through an input/output interface (532) and may be recorded in a database (534), along with a time-stamp generated at that instant by a system clock (536). The controller (530) may also initiate one or more software programs (538) to analyze the signal, identify the unique ID tag (510) and reader (520) from which it came, and take other steps such as associating it with a particular student based on information stored in the database (534) and updating the database based on such information. In appropriate circumstances, the program (538) may also cause a reaction signal (538) to be sent back to the reader (520) and/or tag (510) to cause some desired action to occur.

### DETAILED DESCRIPTION OF THE INVENTION

In general, the present invention provides a system for generating, gathering, transmitting, storing, analyzing and acting on certain information in an institutional environment such as a school. RFID tags placed on personnel, in the form of identification tags or stickers, and select assets can, when interacting with readers located throughout the environment, generate and collect information about the precise location and state of a uniquely-identified individual and/or asset. Such information may be transmitted, either via wires or wirelessly, from such readers to at least one serve or system controller, containing at least one database and one or more software programs. Depending upon the nature of the information received, the controller may store the received information in said database, including the precise time it was received, and initiate additional steps in the form of running one or more software programs that take the information as input and through a set of decision rules contained therein generate output signals that can initiate certain actions, as described more fully below. In one preferred embodiment of the invention, upon the taking of such actions, additional signals will be generated by RFID tags, collected by readers, transmitted to one or more controllers, analyzed by one or more software programs to verify that the prescribed actions were taken, and stored in one or more databases.

Additionally, the present invention provides a method of generating and collecting information about the location and state of personnel and important assets in an institutional environment by generating, receiving and transmitting such information, time-stamping and storing such information for future reference, analyzing it, including by comparing it to certain criteria, generating certain reaction signals that may cause some desired action, when appropriate, and in such instances repeating the foregoing process to verify that the desired action was undertaken.

Thus, in a preferred embodiment of the invention, RFID tags may be placed on or embedded in a variety of objects in a school environment such as student identification tags, medications in a school infirmary, valuable assets like musical instruments, library books, food containers in the cafeteria, and the like. RFID readers can be located at strategic locations in the school environment such as building entrances and exits, hallways (especially hallways intersections and corners), doorways to classrooms, the school infirmary, the library, the cafeteria, the office and other significant locations. A server or system controller may be located in a secure location and it may be connected to various output devices, including one or more personal computers through which reports of system operation may be provided. The system controller contains or accesses a database of information about the objects bearing RFID tags in the school environment, including the precise location and state of same. The system controller also contains or accesses one or more software programs containing decision rules related to information about the precise location and state of objects bearing RFID tags and relevant functions and activities within the school environment.

Further features of the invention are illustrated in the following exemplary embodiments.

In an exemplary embodiment involving a student interaction, a student arrives at school bearing a student ID tag. Upon reaching the school building entrance, a reader generates a radio signal and records a response from the student ID tag, which is transmitted to the system controller where it is identified and compared to relevant students' records in the database and associated with a particular student, whereupon the database may be updated to show the student as present in the building.

In another exemplary embodiment, when the student gets to within a specified distance of her locker (such as from 1 to 10 feet), a reader generates a radio signal, records a response signal from the student's ID tag, relays the response signal to a controller which identifies said signal and employs a software program to compare it with student identification information in a database, associates it with a particular student, determine if the particular locker is assigned to the particular student and, if so, generates a reply signal that is received at the locker and causes it to open up automatically. In one embodiment, the locker may close automatically when the student moves away from it beyond the range of the reader, or after a designated interval of time. In another embodiment, a button inside may be pressed to close the locker.

In another exemplary embodiment, a student goes to a particular classroom, and upon passing a reader at the classroom door, the reader generates a radio signal, records a response signal from the student's ID tag, relays the response signal to a controller which identifies said signal and employs a software program to compare it with student identification information in a database, associates it with a particular student, determines if the particular student is assigned to the particular classroom and, if so, records her attendance (or sends a report indicating a discrepancy to administrative officials), and automatically records attendance by updating the database to show the student as present in the class and noting the time. This procedure may be repeated for each class as each student enters and exits.

In another exemplary embodiment, a student gets into a lunch line, puts food in containers bearing RFID tags on a tray, and as she walks past a reader, the reader generates radio signal, records response signals from the student's ID tag and the food container tags, relays the response signals to a controller which identifies said signals, associates them with a particular student, and employs one or more software programs to compare them with food identification and price information and student identification information in one or more databases and determines if the particular student has enough credit in her account to purchase all of the items (and if not, generates an exception report for administrative officials), and debits the student's spending account by updating the databases accordingly.

In another exemplary embodiment, when a student goes to a band or orchestra room in a school, the reader generates a radio signal, records a response signal from the student's ID tag and an RFID tag attached to a musical instrument, relays the response signal to a controller which identifies said signals and employs a software program to compare them with student identification information and instrument information in one or more databases, associates same with a particular student, determines if the particular student may use or remove from the music or orchestra room the particular musical instrument (and if not, generates an exception report or sounds an alarm for administrative officials), and records the status of the musical instrument and the student's activity accordingly.

In another exemplary embodiment, when a student goes to the school library to retrieve a book, the reader generates a radio signal, records a response signal from the student's ID tag an RFID tag in the book chosen, relays the response signal to a controller which identifies said signals and employs a software program to compare them with student identification information and book identification information in one or more databases and student's library account, associates same with a particular student, determines if the particular student may check out the particular book (and if not, generates an exception report for administrative officials), and notates student's account and library inventory by updating the databases accordingly. Further, the software program may send a signal to cause an alarm to sound if the student is attempting to remove a book from the library that she is not authorized to have.

In another exemplary embodiment employing the process described above, when a student needs to take her medication, a program in the system controller causes a light on signal to be generated that is sent to a reader which relays such signal and causes the Student's ID to light up. When the Student goes to the nurse to receive such medication, a tag on Student's medicine bottle will signal when bottle is accessed. In a further embodiment, a signal generated by a software program in the controller can alert the nurse if the student is taking the wrong medicine.

The foregoing description of the invention is presented for illustration and is not intended to be exhaustive or to limit the invention to the precise form disclosed. Other modifications and variations may be possible in light of the foregoing teachings. The embodiment described was chosen to best explain the invention and thereby to enable others skilled in the art to best utilize the invention in various embodiments and modifications suited to particular uses. It is intended that the following claims be construed to include other alterative embodiments of the invention except insofar as limited by the prior art.

What is claimed is:

1. A system for automatically generating, gathering, transmitting, storing, and analyzing information in institutional environments, comprised of
one or more RFID tags placed on one or more items or persons,
one or more RFID readers located within the institutional environment capable of generating and receiving signals from at least one RFID tag,
one or more controllers capable of receiving signals from at least one RFID reader, on which are stored
one or more databases containing information about the environment, and
one or more software programs including decision rules and capable of performing one or more analyses or functions associated with activities in the institutional environment.

2. The system of claim 1 wherein the signals from at least one RFID tag uniquely identify the person or item with which such RFID tag is associated.

3. The system of claim 2 wherein said RFID readers are located so as to be able to read the RFID tags of persons entering or exiting a particular building room or space.

4. The system of claim 3 wherein said database is able to be updated to show the attendance, presence or status of a particular person or item in a particular building, room, space or location.

5. The system of claim 1 further comprising a controller that includes a clock mechanism capable of time-stamping signals received from an RFID reader.

6. The system of claim 2 wherein the signals from RFID tags indicate a particular person taking physical control of a particular item.

7. The system of claim 6 wherein said item is a library book, musical instrument or container of food.

8. The system of claim 7 wherein an account associated with said particular person is charged a specified amount associated with said item.

9. They system of claim 4 further comprising means for reporting the presence or status of particular persons or items in particular locations to system administrators.

10. The system of claim 4 further comprising means for sending signals from said controller through particular RRID readers to particular RFID tags to cause certain desired actions to be taken.

11. A method for automatically generating, gathering, transmitting, storing and analyzing information in an institutional environment by
generating and receiving signals containing information specific to the bearer of one or more RFID tags,
reading said signals,
forwarding said signals to a controller,
identifying a specific RFID tag from which a given signal was received, and
storing said signal in a database.

12. The method of claim 11 further comprising applying relevant decision rules to information contained in said signal.

13. The method of claim 12 further comprising generating a response or order based on such decision rules.

14. The method of claim 13 further comprising performing a function based on such response or order.

15. The method of claim 14 further comprising creating and sending a report of the process to an administrative authority.

16. A locker system comprised of
a locker with a locking and unlocking mechanism that can be activated by radio signals
an RFID tag
an RFID reader
a controller containing a database and one or more software programs including decision rules and capable of generating a signal to lock or unlock said locker.

17. The locker system of claim 16 wherein said database is capable of storing information identifying the individual to whom the locker is assigned and said software program is capable of identifying a signal from an RFID tag worn by such individual and generating a signal to lock or unlock said locker.

18. The locker system of claim 17 wherein the presence of a specified RFID tag within a specified proximity of said locker causes said software program to generate a signal to unlock said locking mechanism on said locker.

19. The locker system of claim 17 wherein the movement of a specified RFID tag from within a specified proximity of said locker causes said software program to generate a signal to lock said locking mechanism on said locker.
